(19) United States
(12) Patent Application Publication
(10) Pub. No.: US 2026/0295695 A1
(43) Pub. Date: Oct. 1, 2026

(54) CUTTING MACHINE AND ELECTRIC WORK MACHINE

(71) Applicant: MAKITA CORPORATION, ANJO-SHI (JP)

(72) Inventors: Yuto YOSHIDA, Anjo-shi (JP); Hiroto KOREKAWA, Anjo-shi (JP); Toshiyuki KANI, Anjo-shi (JP)

(21) Appl. No.: 19/557,566

(22) Filed: Mar. 5, 2026

(30) Foreign Application Priority Data
Mar. 28, 2025 (JP) 2025-055804
Mar. 28, 2025 (JP) 2025-055817

(51) Int. Cl. B23D 47/12; B23D 45/04

(52) U.S. Cl. CPC B23D 47/12; B23D 45/048

(57) ABSTRACT

A cutting machine (1) includes a motor shaft (23a) of an electric motor (23), a first intermediate shaft (32) and an output shaft (37). The first intermediate shaft (32) is rotated about its axis by the rotational energy output by the motor shaft (23a). The output shaft (37) is rotated about its axis by the rotational energy output by the first intermediate shaft (32) so as to cause a cutting tool (11) mounted thereon to rotate. A fan (24) is mounted on the first intermediate shaft (32). The fan (24) is rotatable about its axis with the first intermediate shaft (32) so as to generate a draft that cools the electric motor (23) and the first intermediate shaft (32).

### CROSS-REFERENCE

The present application claims priority to Japanese patent application serial number 2025-055804 and 2025-055817, both filed on Mar. 28, 2025, the contents of which are hereby fully incorporated by reference.

### TECHNICAL FIELD

The present invention relates to a cutting machine, e.g., a benchtop cutting machine, and an electric work machine, such as a sliding compound miter saw (e.g., a dual-bevel sliding compound miter saw).

### BACKGROUND ART

US 2023/0241694 (A1) discloses a benchtop cutting machine that comprises a cutting-machine main body that is pivotably and slidably coupled to a turntable so as to be tiltable in an up-down direction relative to the turntable. The cutting-machine main body comprises a motor having a motor shaft, and the output of (i.e. the rotational energy output by) the motor is transmitted to an output shaft via an intermediate shaft. A cutting tool (e.g., a circular saw blade) mounted on the output shaft rotates with the output shaft. A fan is mounted on the motor shaft. A draft, which is generated by the fan, cools the motor and is exhausted from a motor housing.

### SUMMARY OF THE INVENTION

Therefore, it would be desirable to provide a structure for cooling a member other than the motor, such as the intermediate shaft, by the fan.

According to one aspect of the present disclosure, a cutting machine comprises a motor having a motor shaft, an intermediate shaft and an output shaft. The intermediate shaft is directly or indirectly connected to the motor shaft and is rotated about its axis by the output of (i.e. the rotational energy output by) the motor shaft. The output shaft is directly or indirectly connected to the intermediate shaft and is rotated about its axis by the output of (i.e. the rotational energy output by) the intermediate shaft so as to cause a cutting tool mounted thereon to rotate. A fan is mounted on the intermediate shaft. The fan rotates about its axis with the intermediate shaft so as to generate a draft for cooling the motor and the intermediate shaft. In this aspect of the present teachings, the fan is mounted on the intermediate shaft, not on the motor shaft. By mounting the fan on the intermediate shaft, the fan cools not only the motor, but also the intermediate shaft. Moreover, the path of the draft is made longer along the motive-power path, which includes the intermediate shaft. Thereby, the cooling effect can be improved, when utilized with a housing that covers the motive-power path. It is noted that one or a plurality of intermediate shafts may be provided between the motor shaft and the output shaft.

### BRIEF DESCRIPTION OF THE DRAWINGS

FIG. 1 is an oblique view, viewed from the right, of a benchtop cutting machine according to a first embodiment.

FIG. 2 is a right view of the benchtop cutting machine in a state in which the cutting-machine main body is located at the top dead center.

FIG. 3 is a front view of the benchtop cutting machine in the state in which the cutting-machine main body is located at the top dead center.

FIG. 4 is a right view of the benchtop cutting machine in a state in which the cutting-machine main body is located at the bottom dead center.

FIG. 5 is a rear view of the benchtop cutting machine in the state in which the cutting-machine main body is located at the top dead center.

FIG. 6 is a left view of the benchtop cutting machine in the state in which the cutting-machine main body is located at the top dead center.

FIG. 7 is a cross-sectional view taken along line VII-VII in FIG. 2.

FIG. 8 is a cross-sectional view taken along line VIII-VIII in FIG. 2.

FIG. 9 is an oblique view, viewed from the left, of an intermediate-shaft housing.

FIG. 10 is a rear view of a fan.

FIG. 11 is a cross-sectional view of a cross-section-reduced part according to a second embodiment.

FIG. 12 is a cross-sectional view of a cross-section-reduced part according to a third embodiment.

FIG. 13 is a cross-sectional view of a cutting-machine main body according to a fourth embodiment.

### DETAILED DESCRIPTION OF THE INVENTION

According to one feature of the present disclosure, the intermediate shaft is directly coupled to the motor shaft (rotor), or rotates about its axis at the same rotational speed as the motor shaft. Thus, the intermediate shaft is disposed close to the motor. For example, the intermediate shaft is preferably coupled, e.g., spline coupled, to the motor shaft without any intervening reduction gears or the like. Consequently, the fan, which is provided on the intermediate shaft, can effectively cool the motor, which is located relatively close to the fan.

According to another feature of the present disclosure, the intermediate shaft comprises an upstream end part (portion), which receives the output from (is coupled to) the motor shaft, and a downstream end part (portion), which transmits the output (rotational energy) from the motor shaft to the output shaft, either directly or indirectly (e.g., via one or more intervening gear stages). The fan is located on the side, on which the downstream end part is located, of the longitudinal center of the intermediate shaft. Therefore, the draft, which flows from the motor, passes a majority of the intermediate shaft and reaches the fan. Thereby, the intermediate shaft can be effectively cooled.

According to another feature of the present disclosure, the axial length of the fan is longer than 1/4 of the diameter of the fan. Thus, the fan is elongated in its axial direction and has a small diameter. Consequently, the diameter of an intermediate-shaft housing, which houses the fan and the intermediate shaft, can be made smaller without reducing the volume of the draft generated by the fan.

According to another feature of the present disclosure, the axial center line of the intermediate shaft is in a virtual orthogonal plane, which is orthogonal to the output shaft, or is inclined by 10° or less relative to the virtual orthogonal plane. In embodiments in which the cutting tool is a saw blade (preferably a circular saw blade), the intermediate shaft is oriented to be substantially parallel to the disk surface of the saw blade. Consequently, enlargement of the cutting-tool main body in the direction of the output shaft can be avoided.

According to another feature of the present disclosure, the motor shaft and the intermediate shaft are coaxially disposed. Therefore, a housing that covers the motor shaft and the intermediate shaft can be made smaller in a radial direction. Or the draft for cooling the motor and the intermediate shaft flows substantially straight. Consequently, a reduction of the volume of the draft can be curtailed.

According to another feature of the present disclosure, the motor is housed by (in) a motor housing, which is made from a synthetic resin (polymer). The intermediate shaft is housed by (in) an intermediate-shaft housing, which is made of a light metal. Therefore, insulation of conductive parts around the motor can be ensured by the motor housing. And, the heat generated in the intermediate shaft can be transmitted to the light-metal intermediate-shaft housing, which serves as a heat sink for cooling the intermediate shaft.

According to another feature of the present disclosure, the fan is disposed such that the fan overlaps a saw blade, which is the cutting tool, in a side view, which is in the axial direction of the output shaft. Therefore, the fan is installed in a space around the saw blade that has a relatively large area. Consequently, the cutting machine can be made more compact.

According to another feature of the present disclosure, the motor is an AC motor. AC motors generate more heat than DC motors and have a large volume. Therefore, the present feature exhibits remarkable cooling efficiency and a remarkable downsizing effect as well.

According to another feature of the present disclosure, two bearings support the intermediate shaft to be rotatable about its axis. The fan is located between the two bearings. Therefore, the two bearings stably support the fan and the intermediate shaft.

According to another feature of the present disclosure, a fan-housing part houses the fan. An intermediate-shaft-housing part, which has a smaller cross-sectional area than the fan-housing part, is provided. The intermediate-shaft-housing part houses a portion of the intermediate shaft on an upstream side of the fan in the draft. A buffer part, which comprises a step caused by a difference in the cross-sectional area between the intermediate-shaft-housing part and the fan-housing part, is provided. Therefore, the draft passes the intermediate-shaft-housing part, which has the small cross-sectional area, and reaches the fan-housing part, which has the large cross-sectional area. Then the draft is dispersed by the buffer part before the fan. Thereby, the draft can flow smoothly.

According to another feature of the present disclosure, the fan comprises one or blades that extend(s) radially. The (each) blade comprises a blade-inner-peripheral part (radially inward portion), which bulges in a rotational direction, on the rotation inner-circumference side; i.e. on the radially inward portion of the fan. The (each) blade comprises a blade-outer-peripheral part (radially outward portion), which bulges in a direction opposite to the rotational direction, on the rotation outer-circumference side; i.e. on the radially outward portion of the fan. In other words, the (each) blade extends in the radial direction in an irregular S-shape or irregular wave-shape. This configuration of the blade(s) enables the blade(s) to generate a strong draft.

According to another feature of the present disclosure, the (each) blade-outer-peripheral part comprises a reverse inclined part, which extends from a bottom of a recess in the rotational direction and in a radially outward direction. An entirety of the reverse inclined part(s) is located in a region that is radially outward of one half of the radius of the fan. Thus, the reverse inclined part(s) is (are) located only in an outer circumferential region (portion) of the fan. Thereby, the fan can effectively generate the draft.

According to another feature of the present disclosure, the (each) blade-outer-peripheral part comprises a reverse inclined part, which extends from a bottom of a recess in the rotational direction and in the radially outward direction. An entirety of the reverse inclined part(s) is located in a region that is radially outward of the middle of the radial length of the blade. Thus, the reverse inclined part(s) is (are) located only in an outer circumferential region (portion) of the fan. Thereby, the fan can effectively generate the draft.

According to another feature of the present disclosure, an extension direction of the reverse inclined part(s) at an outer circumferential edge thereof is inclined by 30°–60° relative to a radial line of the fan. In other words, an outer circumferential edge of the reverse inclined part(s) is inclined by 30°–60° relative to a radial line of the fan that extends radially from the center of the fan. This structure enables the blade to effectively generate the draft.

According to another feature of the present disclosure, a fixed cover covers a portion of the cutting tool, and a fan housing houses the fan. One or more exhaust ports is (are) provided in the fan housing. The exhaust port(s) is (are) open toward the fixed cover. Therefore, the draft is exhausted from the fan housing toward the fixed cover. Consequently, the draft is less likely to blow directly toward (against) the user, and/or the volume of the draft that directly blows toward (against) the user can be reduced.

According to another feature of the present disclosure, an electric work machine comprises a motor shaft (rotor) of a motor and an intermediate shaft. The intermediate shaft is disposed coaxially with the motor shaft and is rotated about its axis by (the output of) the motor shaft. A fan is mounted on the intermediate shaft. The fan rotates about its axis with the intermediate shaft so as to generate a draft for cooling the motor and the intermediate shaft.

Thus, the fan is mounted on the intermediate shaft, not on the motor shaft. By mounting the fan on the intermediate shaft, the fan cools not only the motor but also the intermediate shaft. Further, by utilizing the intermediate shaft, the motor shaft can be shortened and a motor housing can be made smaller. Or a path of the draft is made longer along the motive-power path, which includes the intermediate shaft. Thereby, the cooling effect can be improved, when utilized with a housing that covers the motive-power path.

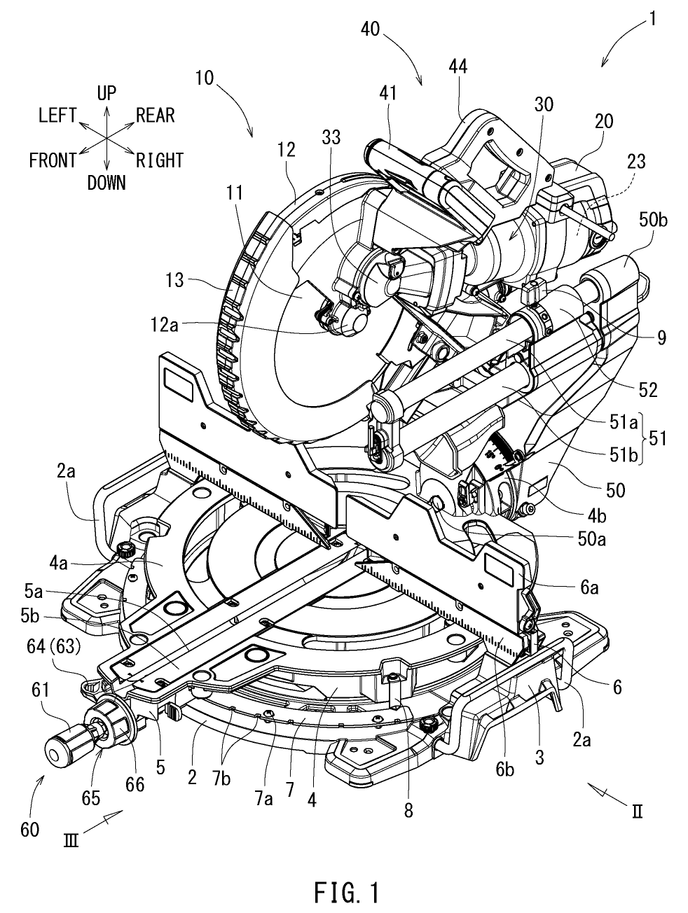

A first embodiment of the present disclosure will now be explained, with reference to FIGS. 1–10. In the present embodiment, a benchtop cutting machine 1, which is a so-called sliding compound miter saw, is illustrated. As shown in FIG. 1, the benchtop cutting machine 1 includes: a base 2 to be placed on a benchtop, the floor, or the like; a turntable (turn base) 4 for a workpiece to be placed upon; and a cutting-machine main body 10. The turntable 4 is supported so as to be rotatable, relative to the base 2, in the horizontal direction (horizontal plane). The cutting-machine main body (carriage) 10 is provided upward of the turntable 4. A substantially discoidal cutting tool (circular-saw blade) 11, which may be, e.g., a carbide-tipped saw blade or a diamond-tipped saw blade, is supported in a rotatable manner by the cutting-machine main body 10. A user performs a cutting operation while positioning themselves on the near side of the benchtop cutting machine 1. In the explanation below, in the front-rear direction, the near side is a front side when viewed from the user. The up-down and left-right directions are defined with reference to the user.

As shown in FIG. 1, the turntable 4 is substantially circular in a plan view, and is provided with a table upper surface 4a that extends horizontally. The base 2 comprises upward-protruding parts 3, which are respectively located on the left and right ends, and the turntable 4 is supported in a horizontally rotatable manner in a space between the left and right upward-protruding parts 3. It is noted that, in the present embodiment, the turntable 4, which is larger than usual, is employed, and therefore the left- and right-end portions of the base 2 do not have placement surfaces (support surface) on which the workpiece can be placed. A pair of holders 2a, 2a are respectively mounted on left and right sides of the base 2, and upper surfaces of the holders 2a, 2a function as auxiliary tables. The turntable 4 includes a table-extension part (extension arm) 5, which extends forward along the side surfaces of the cutting tool 11. A slot 5a, which has a notch shape and extends along the side surfaces of the cutting tool 11, is provided in the center of an upper surface of the table-extension part 5. A kerf board 5b is provided at an upper portion of the slot 5a.

As shown in FIG. 1, a positioning fence (guide fence) 6, which has a wall shape extending in the left-right direction and extending upward, is provided upward of the turntable 4 and the upward-protruding parts 3. The positioning fence 6 is supported by the left and right upward-protruding parts 3. A positioning surface 6b, which is a front surface of the positioning fence 6, lies in a vertical plane that passes through the center of rotation of the turntable 4. The workpiece that is placed on the turntable 4 is positioned in the front-rear direction by making contact with the positioning surface 6b. A pair of movable fences 6a, 6a, which can extend the positioning surface 6b upward, are provided upward of the positioning fence 6. The movable fences 6a, 6a are slidable in the left-right direction, and in the situation in which the movable fences 6a, 6a are in such a positional relationship that they would interfere with the cutting-machine main body 10 when it is tilted, the movable fences 6a, 6a can be slid outward to avoid such interference.

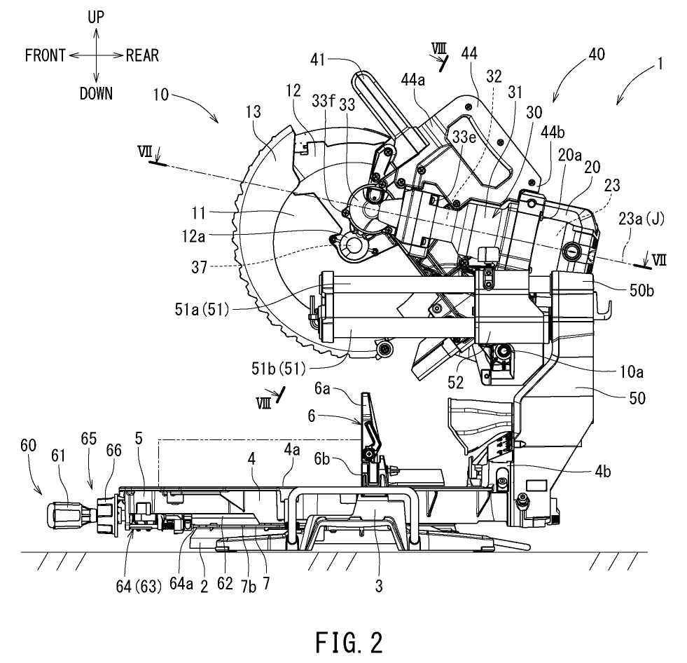

As shown in FIGS. 1 and 2, a miter scale plate 7, which has an arcuate shape, is provided along a substantially half-circumferential region of a front portion of the base 2. The miter scale plate 7 is located downward of the table upper surface 4a and extends horizontally. The miter scale plate 7 cooperates with indicators 8, which are provided on both the left and right sides of the turntable 4, to indicate the rotational angle (miter angle) of the turntable 4. The rotational angle of the turntable 4 is the angle between the cutting tool 11 and a virtual plane that is orthogonal to the positioning surface 6b of the positioning fence 6. When this angle is 0 degrees (i.e. miter angle position: 0°), the workpiece can be cut at a right angle with respect to the longitudinal direction of the workpiece. This cutting is called a right-angle cut (cross cut). By causing the turntable 4 to rotate either leftward or rightward, the cutting tool 11 can be set to an attitude that is angled with respect to the virtual plane that is orthogonal to the positioning surface 6b of the positioning fence 6. The cutting of the workpiece by the cutting tool 11 at this attitude is called a diagonal cut (miter cut). A plurality of groove-shaped positioning, recessed parts 7b, which extend radially, is provided on the miter scale plate 7. The positioning, recessed parts 7b are provided at prescribed angular intervals in the circumferential direction of the miter scale plate 7. The tip of a positioning pin 64a, which is described below, is capable of entering the positioning, recessed part 7b. The miter scale plate 7 is fixed to the base 2 by a plurality of fixing screws 7a. The fixing screws 7a are inserted into slots, which pass through the miter scale plate 7 in the up-down direction. By loosening the fixing screws 7a and then shifting the miter scale plate 7 in the left-right direction, the angle between the positioning fence 6 and the cutting tool 11 can be finely adjusted. For example, if the positioning pin 64a is in the state in which it has been inserted into the positioning, recessed part 7b at a right-angle position, then the right angle between the cutting tool 11 and the positioning fence 6 can be precisely adjusted. This adjustment is performed principally in the product-manufacturing process.

As shown in FIG. 1, a substantially circular-column-shaped arm-support part 4b, in which the front-rear direction is the axial direction, is provided at a rear portion of the turntable 4. A main-body support arm 50, which extends substantially upward, is provided on a rear side of the arm-support part 4b. The main-body support arm 50 is supported so as to be tiltable in the left-right direction relative to the arm-support part 4b about a left-right tilting pivot 50a extending in the front-rear direction. In the state in which the cutting tool 11 is vertical, the main-body support arm 50 is inclined such that it extends generally rightward as it extends upward. An upper part 50b of the main-body support arm 50 has a shape such that, when a below-described slide base 52 has been moved toward its rearmost end, it is retracted from the movable range of the cutting-machine main body 10.

The main-body support arm 50 can be tilted up to 45° in the left and right directions about the left-right tilting pivot 50a. In addition, by switching a tilt-positioning mechanism (which is provided at a rear portion of the main-body support arm 50, although not shown in the drawings for the sake of convenience), the main-body support arm 50 can be further tilted up to a maximum of 48°. Therefore, the cutting tool 11 is also tilted up to a maximum of 48° in the left and right directions about the left-right tilting pivot 50a. By tilting the cutting tool 11 in the left-right direction, a so-called oblique cut (bevel cut) can be performed on the workpiece placed on the turntable 4.

As shown in FIG. 1, elongate slide bars 51, which are parallel to the side surfaces of the cutting tool 11 and extend in the horizontal direction, are mounted on the upper part 50b of the main-body support arm 50. The slide bars 51 comprise an upper first bar 51a and a lower second bar 51b, which are provided in parallel in the up-down direction. The first bar 51a is formed, for example, to have a circular cylindrical shape. The second bar 51b is formed to have a circular cylindrical shape, for example, having a larger diameter than the first bar 51a. The slide base 52 is mounted on the first bar 51a and the second bar 51b such that the slide base 52 is slidable in the front-rear direction. The cutting-machine main body 10 is coupled to the slide base 52 leftward thereof. Consequently, the cutting-machine main body 10 is located more leftward than the first bar 51a and the second bar 51b in the state in which the cutting tool 11 is vertical. By sliding the slide base 52 in the front-rear direction, a workpiece that is placed on the turntable 4 and is, for example, wider than the saw blade 11 can be cut. A knob 9 is provided on an upper surface of the slide base 52. By causing the knob 9 to rotate in a fastening direction, the slide base 52, which slides relative to the slide bars 51, can be fixed at any arbitrary position along the axial direction.

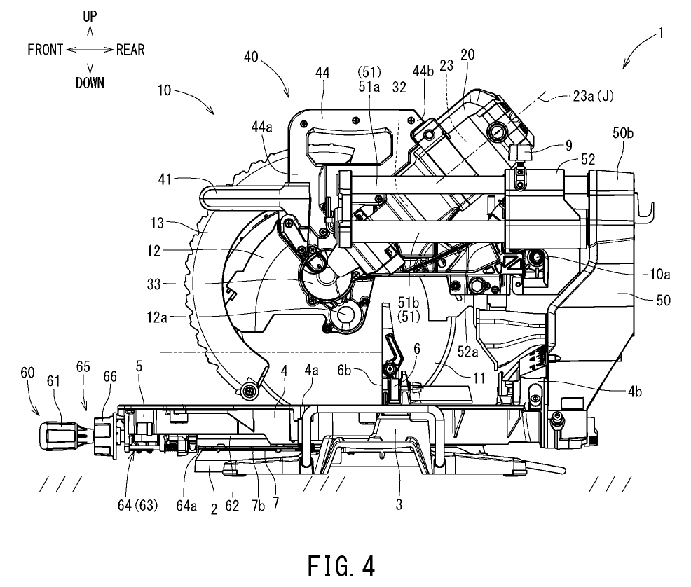

As shown in FIGS. 2 and 4, the cutting-machine main body 10 is swingable relative to the slide base 52 in the up-down direction about an up-down swing shaft 10a, which extends in the left-right direction. The up-down swing shaft 10a is located rearward of the cutting tool 11. By causing the cutting-machine main body 10 to swing downward, the cutting tool 11 can cut into and through the workpiece placed on the turntable 4. With regard to the swing angle of the cutting-machine main body 10 in the up-down direction, if the bottom dead center is set to 0°, the top dead center is 52°. In other words, the cutting-machine main body 10 is capable of swinging up and down over an angular range of 52°. A torsion spring, which biases the cutting-machine main body 10 upward toward the top dead center, is provided around the up-down swing shaft 10a.

As shown in FIGS. 2 and 4, the cutting-machine main body 10 comprises a fixed cover (fixed blade cover) 12 and a movable cover (movable blade cover) 13, which respectively cover an upper portion and a lower portion of the cutting tool 11. That is, the fixed cover 12 covers, on both the left and right sides and radially outward, the extent of the upper-side, half circumference of the cutting tool 11. The movable cover 13 is capable of covering the extent of the lower-side, half circumference of the cutting tool 11. The movable cover 13 rotates in conjunction with the up-down swinging of the cutting-machine main body 10 and opens and closes over the extent of the lower-side, half circumference of the cutting tool 11. When the cutting-machine main body 10 is being swung upward, the movable cover 13 rotates in a closed-position direction (counterclockwise direction in FIG. 2). Consequently, when the cutting-machine main body 10 is located at the top dead center, the lower-side half circumference range of the cutting tool 11 is covered. On the other hand, when the cutting-machine main body 10 is being swung downward, the movable cover 13 rotates in an open-position direction (clockwise direction in FIG. 4). Consequently, the lower-side, half circumference portion of the cutting tool 11 is exposed, and therefore the cutting tool 11 can cut into the workpiece placed on the turntable 4.

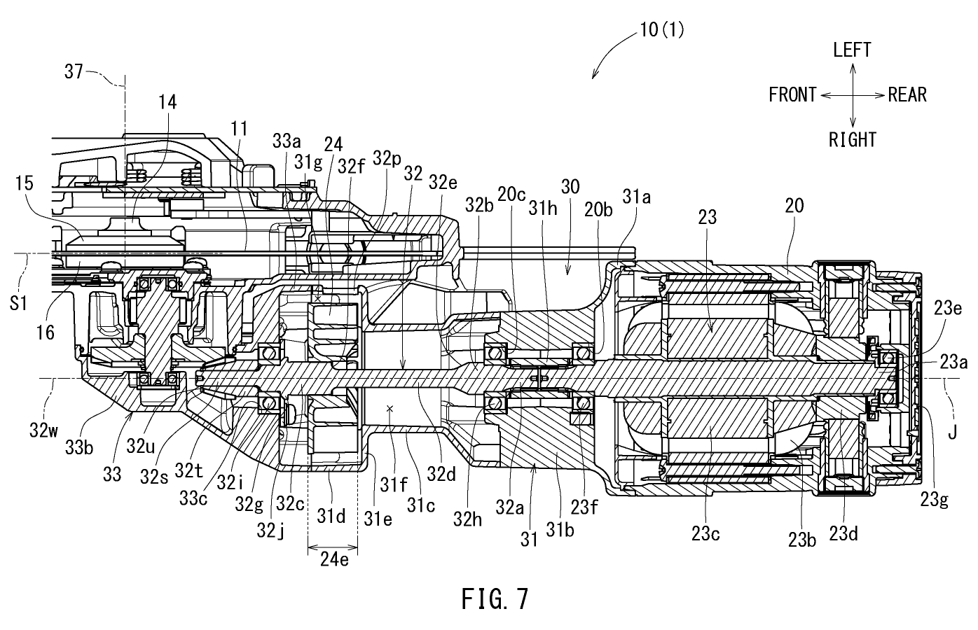

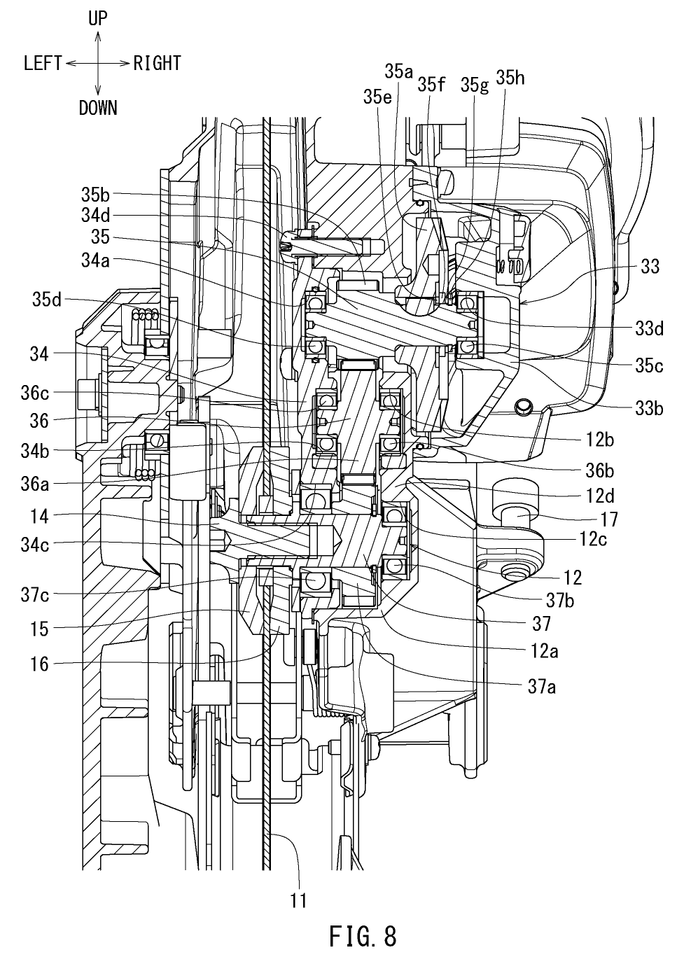

As shown in FIGS. 7 and 8, the cutting tool 11 is integrally (detachably fixedly) mounted on an output shaft 37, which extends in the left-right direction and is supported in a rotatable manner on the cutting-machine main body 10. The cutting tool 11 rotates with the output shaft 37 about the axis of the output shaft 37. The cutting tool 11 is mounted on the output shaft 37 by tightening a fixing screw 14 while the center of rotation of the cutting tool 11 is sandwiched by (between) an outer flange 15 and an inner flange 16.

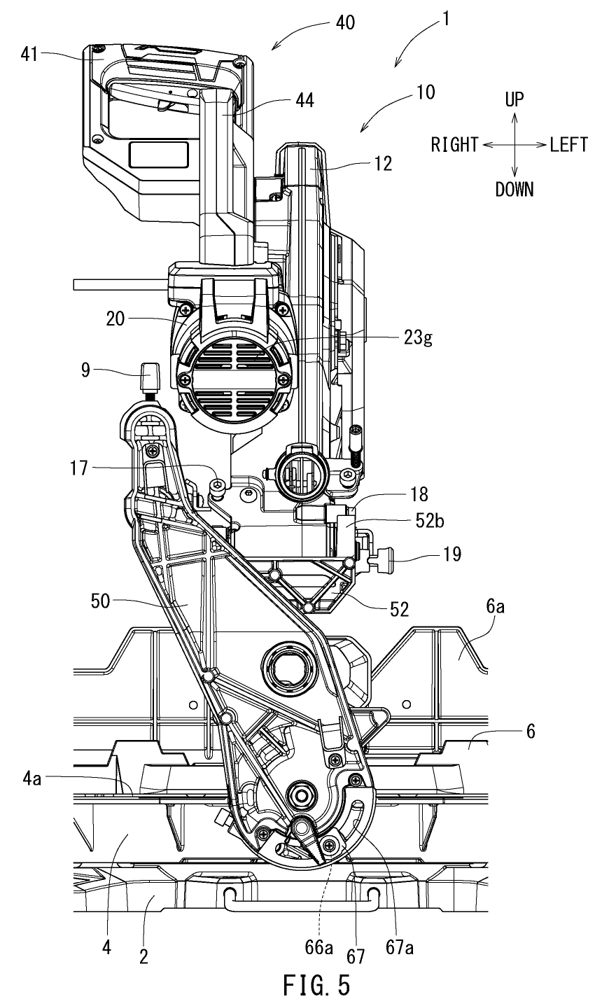

As shown in FIG. 5, a bottom-dead-center stopper 17 is provided on a right-side portion of the cutting-machine main body 10. The bottom-dead-center stopper 17 comprises a bolt, which is screw-coupled to the cutting-machine main body 10 and protrudes downward. The protrusion length of the bottom-dead-center stopper 17 (i.e. the length by which the bottom-dead-center stopper 17 protrudes) can be changed by, for example, inserting a hexagonal-rod wrench (spanner), such as a hex key or Allen wrench, into a hexagonal hole in the head portion of the bolt and rotating the hexagonal-rod wrench. Thereby, the location of the bottom dead center of the cutting-machine main body 10 can be finely adjusted. A bottom-dead-center-stopper contact part 52a (refer to FIG. 4), which abuts the tip of the bottom-dead-center stopper 17 when the cutting-machine main body 10 is lowered to the bottom dead center, is provided on the front surface of the slide base 52. The bottom-dead-center-stopper contact part 52a is a flat surface that is provided on an upper surface of a projection portion that protrudes forward from the front surface of the slide base 52.

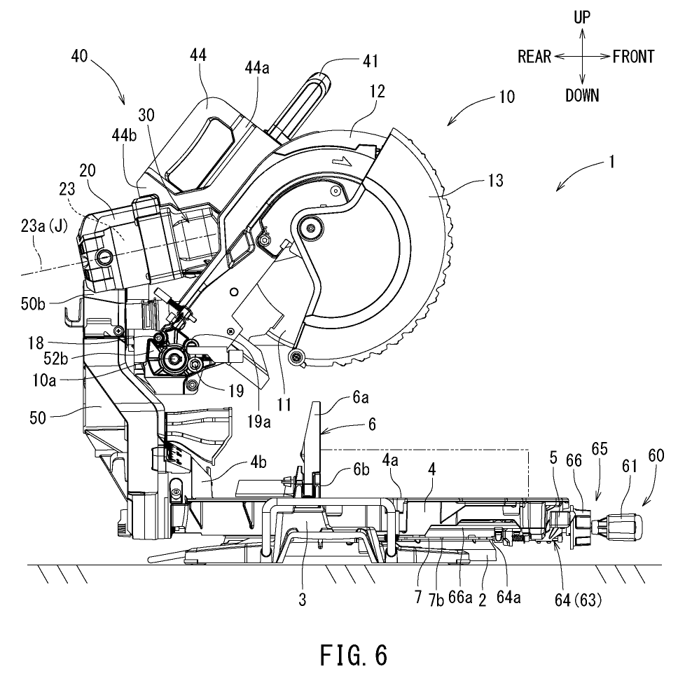

As shown in FIGS. 5 and 6, a top-dead-center stopper 18, which protrudes leftward, is provided at a left-side portion of the fixed cover 12. A top-dead-center-stopper contact part 52b, which is planar and is capable of abutting the top-dead-center stopper 18, is provided on the upper surface of the left-side portion of the slide base 52. The upward movement of the cutting-machine main body 10 is stopped at the top dead center by the top-dead-center stopper 18 and the top-dead-center-stopper contact part 52b abutting each other.

As shown in FIG. 6, a bottom-dead-center lock pin 19, which protrudes leftward, is provided on a left-side surface of a front portion of the slide base 52. A through hole 19a, which extends in the left-right direction on the front side of the top-dead-center stopper 18, is provided in the fixed cover 12. The bottom-dead-center lock pin 19 is capable of entering the through hole 19a by moving rightward when the cutting-machine main body 10 moves toward the bottom dead center. The cutting-machine main body 10 can be locked at the bottom dead center by pushing the left end of the bottom-dead-center lock pin 19 rightward so that the bottom-dead-center lock pin 19 enters the through hole 19a.

As shown in FIGS. 2 and 4, the cutting-machine main body 10 comprises a motor housing 20 between the cutting tool 11 and the slide bars 51 in the left-right direction. The motor housing 20 is made from a synthetic resin (polymer). An electric motor 23 is housed in the motor housing 20. A motor shaft 23a is provided at the center of the electric motor 23. The motor shaft 23a extends in the front-rear direction along a motor axis J, which is parallel to the side surfaces of the cutting tool 11.

As shown in FIG. 7, a motor, which operates (is driven) using electric power supplied from an AC power supply and is called an AC brushed motor, is used as the electric motor 23. The motor shaft 23a is supported by a first bearing 23e and a second bearing 23f such that it is rotatable about the motor axis J. An inner ring of the first bearing 23e is press-fitted onto the rear end of the motor shaft 23a, and an outer ring of the first bearing 23e is press-fitted into a hole provided at a rear end of the inside of the motor housing 20. An inner ring of the second bearing 23f is press-fitted onto a front portion of the motor shaft 23a, and an outer ring of the second bearing 23f is press-fitted into a hole 20b provided in a below-described hub-holding part 31b.

As shown in FIG. 7, a stator 23b of the electric motor 23 is supported in a non-rotatable manner on an inner-peripheral surface of the motor housing 20. A rotor 23c of the electric motor 23 is rotatably disposed within the stator 23b. The rotor 23c is mounted along the outer circumference of the motor shaft 23a and is rotatable together with the motor shaft 23a. A commutator 23d is mounted rearward of the rotor 23c. Air-intake ports 23g, which are capable of taking in outside air, are provided in a rear surface of the motor housing 20.

As shown in FIG. 2, the cutting-machine main body 10 comprises a motive-power transmitting part 30, which transmits the driving force of the motor shaft 23a to the output shaft 37, between the cutting tool 11 and the slide bars 51 in the left-right direction. The motive-power transmitting part 30 is housed in an intermediate-shaft housing 31, a gear housing 33, and a gear-housing part 12a, which is provided at a right-side portion of the fixed cover 12. The intermediate-shaft housing 31 is coupled to an opening in the front end of the motor housing 20. The gear housing 33 couples an opening in the front end of the intermediate-shaft housing 31 and an opening in the right end of the gear-housing part 12a.

As shown in FIG. 7, the intermediate-shaft housing 31 is substantially circular-tube shaped and extends along one of the side surfaces of the cutting tool 11. The intermediate-shaft housing 31 is formed by a motor-housing coupling part 31a, the above-mentioned hub-holding part 31b, a reduced-part housing 31c and a fan housing 31d that are aligned along the motor axis J. The motor-housing coupling part 31a is coupled to the front end of the motor housing 20 by a plurality of fixing screws 20a (refer to FIG. 2). The fan housing 31d is coupled to an intermediate-shaft-housing coupling part 33a at the rear end of the gear housing 33 by a plurality of fixing screws 33e extending along the direction of the motor axis J.

An area of a cross section, which is orthogonal to the front-rear direction, of the motor-housing coupling part 31a is the largest in the intermediate-shaft housing 31. A cross-sectional area of the intermediate-shaft housing 31 decreases stepwise, as it extends from the motor-housing coupling part 31a to the reduced-part housing 31c. A cross-sectional area of the fan housing 31d is larger than that of the hub-holding part 31b and smaller than that of the motor-housing coupling part 31a. The fan housing 31d comprises a wall-shaped buffer part 31e, which rises, in an orthogonal manner, radially outward from the reduced-part housing 31c.

As shown in FIG. 7, a first intermediate shaft 32, which linearly extends in an elongated form, is housed in the intermediate-shaft housing 31. The first intermediate shaft 32 is disposed coaxially with the motor shaft 23a. Outer circumferential surfaces of the front end of the motor shaft 23a and an upstream end part 32a at a rear portion of the first intermediate shaft 32 are each splined. The front end of the motor shaft 23a and the upstream end part 32a at the rear portion of the first intermediate shaft 32 are inserted into a hub 31h, whose inner circumference is splined, and are thereby coupled in a manner capable of transmitting rotational power. The first intermediate shaft 32 comprises an upstream part 32b at the rear portion thereof, a downstream part 32c at a front portion thereof, and a cross-section-reduced part 32d located between the upstream part 32b and the downstream part 32c. The cross-section-reduced part 32d is housed in an intermediate-shaft-housing part 31f inside the reduced-part housing 31c. The cross-section-reduced part 32d has a radial cross-sectional area that is smaller than the upstream part 32b and the downstream part 32c. The cross-section-reduced part 32d is disposed such that it overlaps the cutting tool 11 in a side view. The cross-section-reduced part 32d in the first embodiment forms a small-diameter part (smaller-diameter part) 32d, which is narrowed over (around) its entire circumference; that is the cross-section-reduced part 32d of this embodiment has a circular cross-section. The small-diameter part 32d undergoes elastic deformation more easily than other larger portions of the intermediate shaft 32, owing to its smaller cross-sectional area. The small-diameter part 32d is actively twisted when a relatively large load is applied thereto by a braking force or the like, e.g., when cutting a relatively hard workpiece. Thereby, the small-diameter part 32d functions as a torsion bar and is capable of cushioning impacts to gears.

As shown in FIG. 7, a rear inclined surface 32e, which causes the outer diameter to gradually become smaller as it extends forward, is formed on the outer circumferential surface between the upstream part 32b and the small-diameter part 32d. The rear inclined surface 32e linearly extends, when viewed from radially outward. A front inclined surface 32f, which causes the outer diameter to gradually become larger as it extends forward, is formed on the outer circumferential surface between the small-diameter part 32d and the downstream part 32c. The front inclined surface 32f extends in a shape of a curved surface, when viewed from radially outward. The front inclined surface 32f steeply extends relative to the outer circumferential surface of the downstream part 32c. The downstream part 32c comprises a flange part 32g, which protrudes radially outward, like a flange, from a portion of the downstream part 32c. The ratio of the diameter of the small-diameter part 32d to the diameter of the downstream part 32c without the flange part 32g is 30%–80%. For example, the diameter of the downstream part 32c is 15 mm relative to the 8 mm diameter of the small-diameter part 32d, and in this case, the ratio is 8 mm/15 mm and thus 0.53 (53%). Further, the ratio of the diameter to the length of the small-diameter part 32d (diameter/length) is set to 5%–40%. For example, the length of the small-diameter part 32d is 62 mm relative to the 8 mm diameter of the small-diameter part 32d, and in this case, the ratio is 8 mm/62 mm and thus 0.129 (12.9%). Further, the ratio of the diameter of the small-diameter part 32d to the diameter of the upstream end part 32a is 50%–90%. For example, the diameter of the upstream end part 32a is 10.8 mm relative to the 8 mm diameter of the small-diameter part 32d, and in this case, the ratio is 8 mm/10.8 mm and thus 0.74 (74%).

An alloy steel for machine structures, such as a chrome-molybdenum steel (SCM material), a nickel-chrome-molybdenum steel (SNCM material), or the like, is used as the material of the first intermediate shaft 32. For example, a chrome-molybdenum steel is preferably used. The upstream part 32b and the downstream part 32c may be subjected to one or more hardening heat treatments, whereas the small-diameter part 32d is preferably not subjected to a hardening heat treatment. In such an embodiment, the hardness of the small-diameter part 32d is lower than the upstream part 32b and the downstream part 32c and thus the small-diameter part 32d undergoes elastic deformation more easily than the upstream part 32b and the downstream part 32c. That is, twisting of the intermediate shaft 32 about its axis will preferentially occur within the axial range of the small-diameter part 32d.

As shown in FIG. 7, the first intermediate shaft 32 is supported by a third bearing 32h and a fourth bearing 32i such that it is rotatable about the motor axis J. An inner ring of the third bearing 32h is press-fitted onto the upstream part 32b of the first intermediate shaft 32, and an outer ring of the third bearing 32h is press-fitted into a hole 20c, which is provided in the hub-holding part 31b. An inner ring of the fourth bearing 32i is press-fitted onto the downstream part 32c of the first intermediate shaft 32, and an outer ring of the fourth bearing 32i is press-fitted into a hole 33c, which is provided in the intermediate-shaft-housing coupling part 33a. The fourth bearing 32i is prevented from coming out of the hole part 33c by a washer 32j. By respectively positioning the second bearing 23f and the third bearing 32h in the holes 20b, 20c, which are provided in the hub-holding part 31b, the positions of the motor shaft 23a and the first intermediate shaft 32 can be set with high accuracy.

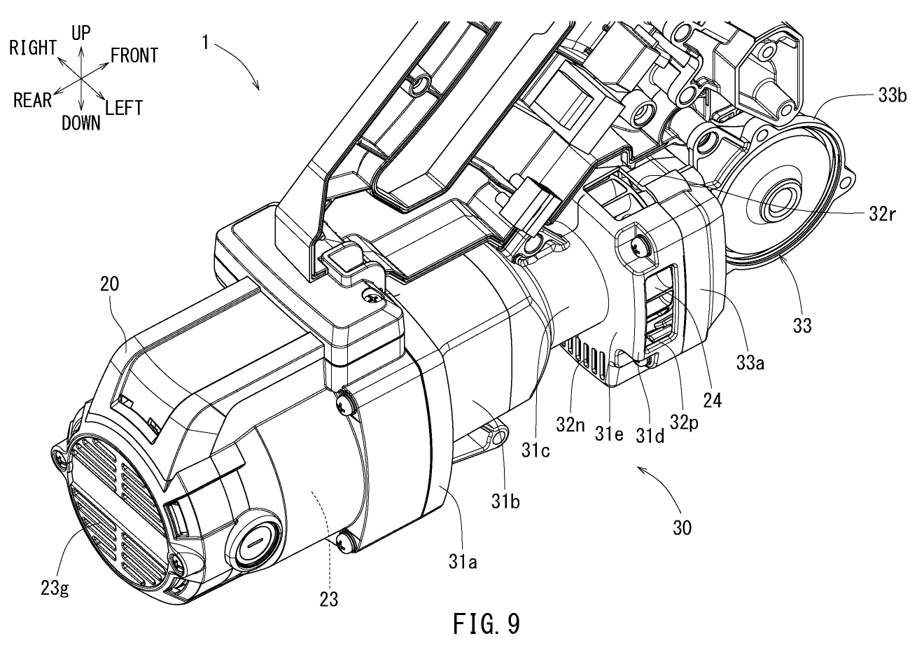

As shown in FIG. 7, a fan 24 is mounted on the first intermediate shaft 32 between (spanning, overlapping) the small-diameter part 32d and the downstream part 32c, such that the fan 24 is rotatable integrally with the first intermediate shaft 32. The fan 24 is housed in a fan-housing part 31g inside the fan housing 31d. When the electric motor 23 is driven and the fan 24 rotates, a cooling draft is introduced from the air-intake ports 23g into the intermediate-shaft housing 31, by way of (through) the motor housing 20. The draft, which has flowed into the intermediate-shaft housing 31, reaches the fan-housing part 31g having a larger cross-sectional area, from the intermediate-shaft-housing part 31f having a smaller cross-sectional area. Thereby, the draft is dispersed, owing to the buffer part 31e, before the fan 24. Then the draft is exhausted from a plurality of exhaust ports 32n, 32p, 32r (see FIG. 9), which are provided in the fan housing 31d. Owing to the cooling draft, the electric motor 23 and the first intermediate shaft 32 is cooled.

As shown in FIG. 9, the exhaust ports of the fan housing 31d comprise rear exhaust ports 32n, which are open rearward from a lower portion of the buffer part 31e. The rear exhaust ports 32n are formed as slots that are elongated in the up-down direction and arranged side-by-side in the left-right direction. In addition, the exhaust ports comprise a left exhaust port 32p, which is wide and open leftward. The air is exhausted from the left exhaust port 32p toward the fixed cover 12. Further, the exhaust ports comprise an upper exhaust port 32r, which is wide and open upward.

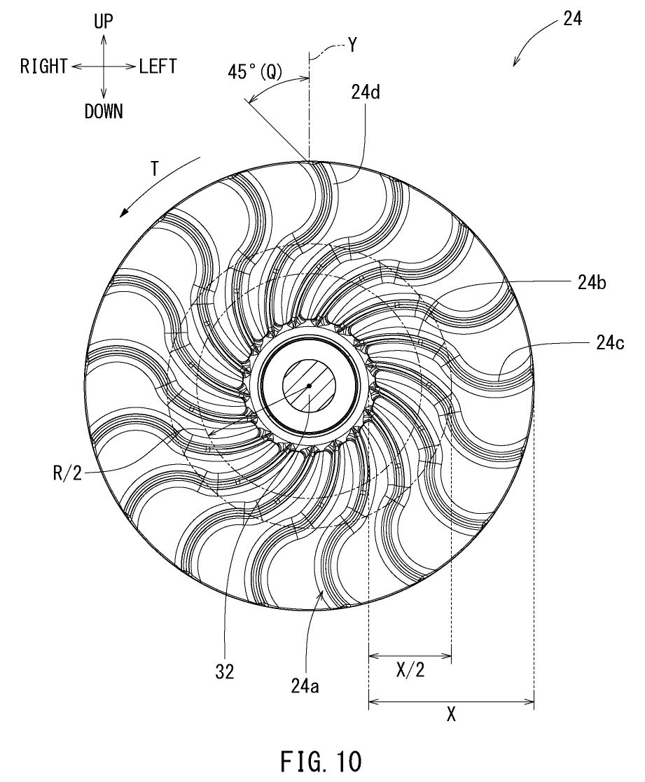

As shown in FIG. 10, the fan 24 comprises blades 24a, each extending radially from the center of rotation of the fan 24. The fan 24 rotates in the counterclockwise direction in the orientation shown in FIG. 10. The blades 24a each comprise a blade-inner-peripheral part (radially inward portion) 24b, which bulges in rotational direction T, on the rotation inner-circumference side (i.e. within the radially inward portion of the fan 24), and a blade-outer-peripheral part (radially outward portion) 24c, which bulges in a direction opposite to the rotational direction T, on the rotation outer-circumference side (i.e. within the radially outward portion of the fan 24). In other words, each blade 24a extends in the radial direction in an irregular S-shape or irregular wave-shape. When the fan 24 rotates, a recess of (in) the blade-outer-peripheral part 24c catches the air, as if scooping the air, and generates a draft. Consequently, the fan 24 can generate the draft with a strong force. The blade-inner-peripheral part 24b and the blade-outer-peripheral part 24c are formed such that they divide a radial region X of the blade 24a into generally two halves. The blade-outer-peripheral part 24c comprises a reverse inclined part 24d, which extends radially outward from the bottom of the recess of the blade-outer-peripheral part 24c in the rotational direction T. Thus, the reverse inclined part 24d is formed (located) outward of one half of the radius R of the fan 24. The reverse inclined part 24d is formed radially outward of an approximate center of the blade-outer-peripheral part 24c. The extension direction of the outer circumferential edge of the reverse inclined part 24d is inclined by, for example, 45°, relative to a virtual radial line Y of the fan 24. This angle Q of the reverse inclined part 24d relative to the virtual radial line Y is preferably between 30°–60°. In addition, the axial length 24e (refer to FIG. 7) of the fan 24 is longer than 1/4 of the diameter of the fan 24. The diameter of the fan 24 is, for example, 68 mm.

As shown in FIG. 7, a drive-side bevel gear 32t is integrally mounted on the downstream end part 32s at the front portion of the first intermediate shaft 32. A circlip 32u for preventing the drive-side bevel gear 32t from coming out is mounted forward of the drive-side bevel gear 32t. The drive-side bevel gear 32t enters (extends into) the gear housing 33.

As shown in FIGS. 7 and 8, the gear housing 33 is shaped such that the intermediate-shaft-housing coupling part 33a, which is open rearward at the rear end, and a fixed-cover coupling part 33b, which is open leftward at a left-side portion, fluidly communicate with each other internally. The gear-housing part 12a of the fixed cover 12 is shaped such that a gear-housing coupling part 12d, which is open rightward at the right end, and an opening into which the output shaft 37 protrudes toward the cutting tool 11, which is leftward, fluidly communicate with each other internally. The fixed-cover coupling part 33b is coupled to the gear-housing coupling part 12d by a spigot-joint structure, which covers the outer circumference of the gear-housing coupling part 12d. The fixed-cover coupling part 33b and the gear-housing coupling part 12d are coupled by a plurality of fixing screws 33f extending in a direction substantially orthogonal to a side surface of the cutting tool 11 (refer to FIG. 2).

As shown in FIG. 8, a second intermediate shaft 35, a third intermediate shaft 36, and the output shaft 37 are each supported, such that they are rotatable about their respective axes, within the gear housing 33 and the gear-housing part 12a. The second intermediate shaft 35, the third intermediate shaft 36, and the output shaft 37 extend in the left-right direction such that they are orthogonal to a side surface of the cutting tool 11. A bearing box 34 is coupled to the left-side surface of the gear-housing part 12a by a plurality of fixing screws 34d extending in the direction substantially orthogonal to a side surface of the cutting tool 11. The bearing box 34 holds the bearings that respectively support the second intermediate shaft 35, the third intermediate shaft 36, and the output shaft 37.

As shown in FIGS. 7 and 8, the second intermediate shaft 35 is supported in a rotatable manner by a fifth bearing 35c and a sixth bearing 35d. An inner ring of the fifth bearing 35c is press-fitted onto the right end of the second intermediate shaft 35, and an outer ring of the fifth bearing 35c is press-fitted into a hole 33d, which is provided on a right side of the interior of the gear housing 33. An inner ring of the sixth bearing 35d is press-fitted onto the left end of the second intermediate shaft 35, and an outer ring of the sixth bearing 35d is press-fitted into a hole 34a, which is provided in the bearing box 34. By respectively positioning the fourth bearing 32i and the fifth bearing 35c in the holes 33c, 33d, which are provided within the gear housing 33, the positions of the first intermediate shaft 32 and the second intermediate shaft 35 can be set with high accuracy. Furthermore, the meshing of the drive-side bevel gear 32t and a driven-side bevel gear 35a can be set with high accuracy.

As shown in FIG. 8, on the right side of the second intermediate shaft 35, the driven-side bevel gear 35a is inserted using a transition fit in a manner movable in the axial direction. The driven-side bevel gear 35a and the second intermediate shaft 35 are rotationally locked relative to one another by the engagement of a key and a key groove. On the right side of the driven-side bevel gear 35a, a washer 35e, which is made of steel, a rubber ring 35f, and a washer 35g, which is made of steel, are mounted on the second intermediate shaft 35. A stop ring 35h is mounted on the second intermediate shaft 35, such that the rubber ring 35f, which is sandwiched by the washers 35e, 35g, is squeezed in the axial direction. The rubber ring 35f cushions impacts, vibration, etc. between the second intermediate shaft 35 and the driven-side bevel gear 35a. The driven-side bevel gear 35a meshes with the drive-side bevel gear 32t. The rotational power of the first intermediate shaft 32 is transmitted to the second intermediate shaft 35 via the meshing between the drive-side bevel gear 32t and the driven-side bevel gear 35a, such that the rotational speed of the second intermediate shaft 35 is less than the first intermediate shaft 32 (while increasing torque) and the rotational direction of the second intermediate shaft 35 is converted to be substantially perpendicular to the rotational direction of the first intermediate shaft 35. A reduction gear 35b is formed, as a component integral with the second intermediate shaft 35, between the driven-side bevel gear 35a and the sixth bearing 35d in the left-right direction.

As shown in FIG. 8, the third intermediate shaft 36 is supported in a rotatable manner by a seventh bearing 36b and an eighth bearing 36c. An inner ring of the seventh bearing 36b is press-fitted onto the right end of the third intermediate shaft 36, and an outer ring of the seventh bearing 36b is press-fitted into a hole 12b, which is provided on a right side of the interior of the gear-housing part 12a. An inner ring of the eighth bearing 36c is press-fitted onto the left end of the third intermediate shaft 36, and an outer ring of the eighth bearing 36c is press-fitted into a hole 34b, which is provided in the bearing box 34. An idler gear 36a is formed, as a component integral with the third intermediate shaft 36, between the seventh bearing 36b and the eighth bearing 36c in the left-right direction. The idler gear 36a meshes with the reduction gear 35b. The rotational power of the second intermediate shaft 35 is transmitted to the third intermediate shaft 36 via the meshing between the reduction gear 35b and the idler gear 36a, such that the rotational speed of the third immediate shaft 36 is less than the second intermediate shaft 35 (while increasing torque).

As shown in FIG. 8, the output shaft 37 is supported in a rotatable manner by a ninth bearing 37b and a tenth bearing 37c. An inner ring of the ninth bearing 37b is press-fitted onto the right end of the output shaft 37, and an outer ring of the ninth bearing 37b is press-fitted into a hole 12c, which is provided on a right side of the interior of the gear-housing part 12a. An inner ring of the tenth bearing 37c is press-fitted onto a center portion of the output shaft 37, and an outer ring of the tenth bearing 37c is press-fitted into a hole 34c, which is provided in the bearing box 34. A reduction gear 37a is formed, as a component integral with the output shaft 37, between the ninth bearing 37b and the tenth bearing 37c in the left-right direction. The reduction gear 37a meshes with the idler gear 36a. The rotational power of the third intermediate shaft 36 is transmitted to the output shaft 37 via the meshing between the idler gear 36a and the reduction gear 37a. The speed of the output shaft 37 is less than that of the second intermediate shaft 35, in accordance with the gear ratio between the reduction gear 35b and the reduction gear 37a. The third intermediate shaft 36 is provided with the idler gear 36a only, and thus exists for the purpose of elongating the inter-shaft distance between the second intermediate shaft 35 and the output shaft 37. Thus, owing to the rotational power of the motor shaft 23a (refer to FIG. 7) being transmitted to the output shaft 37, the cutting tool 11 rotates.

As shown in FIGS. 2 and 4, in the state in which the cutting tool 11 is vertical, regardless of where the cutting-machine main body 10 is located between the top dead center and the bottom dead center, the electric motor 23 is located more upward than the first bar 51a. In the situation in which the cutting tool 11 is in the vertical state and the cutting-machine main body 10 is located at the top dead center, the first intermediate shaft 32 is located more upward than the first bar 51a. In the situation in which the cutting tool 11 is in the vertical state and the cutting-machine main body 10 is located at the bottom dead center, the first intermediate shaft 32 overlaps the slide bars 51 in the up-down direction. In the state in which the cutting tool 11 is vertical and the cutting-machine main body 10 is located at the top dead center, the side of the motor shaft 23a opposite to the gears is inclined upward relative to the horizontal. Thereby, the motor housing 20 overlaps the first bar 51a and the upper part 50b of the main-body support arm 50 in the up-down direction. In the state in which the cutting-machine main body 10 is located at the top dead center, the entirety of the motor shaft 23a is located more rearward than the up-down swing shaft 10a.

As shown in FIG. 7, the motor shaft 23a extends parallel to a side surface of the cutting tool 11. The angle formed by the motor shaft 23a with a side surface of the cutting tool 11 preferably is –10° to 0° to 10° when viewed from the extension direction of the cutting tool 11 and the radial direction of the motor shaft 23a (when the side of the motor shaft 23a opposite to the gears is inclined leftward relative to parallel (0°) to a side surface of the cutting tool 11, it is indicated as minus, and when inclined rightward, it is indicated as plus). If the angle is within this angular range, then it suffices merely to change the axial angle between the drive-side bevel gear 32t and the driven-side bevel gear 35a, which mesh with each other, and therefore there is no need for a major change in the design concept, such as the addition of a component or components. In addition, the first intermediate shaft 32 is coaxial with the motor shaft 23a, and thus the first intermediate shaft 32 also extends parallel to the side surface of the cutting tool 11. In other words, an axial center line 32w of the first intermediate shaft 32 is parallel to a virtual orthogonal plane S1, which is orthogonal to the output shaft 37. The angle formed by the axial center line 32w with the virtual orthogonal plane S1 preferably is –10° to 0° to 10°.

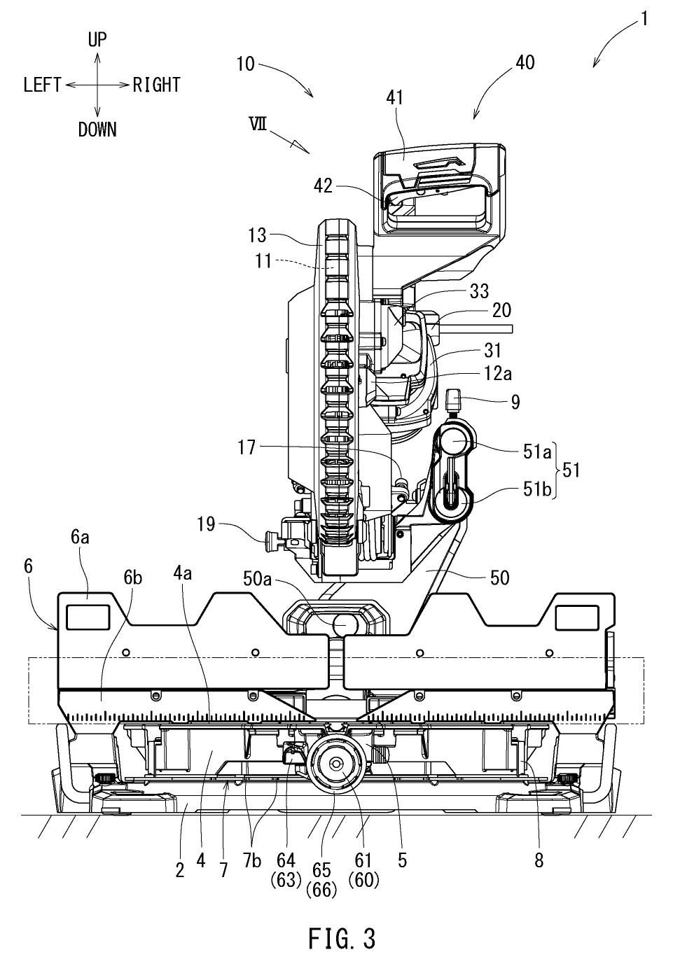

As shown in FIG. 3, the cutting-machine main body 10 comprises a handle part 40, which is more rightward than the side surface of the cutting tool 11 and is forward of the gear housing 33 in the state in which the cutting tool 11 is vertical. A manipulatable handle 41, which has a loop shape and extends in the left-right direction substantially orthogonal to the side surface of the cutting tool 11, is provided at a front portion of the handle part 40. A switch lever 42 is provided on an inner-peripheral side of the manipulatable handle 41. When the user grasps the manipulatable handle 41, the user can pull the switch lever 42 with their finger. When the switch lever 42 is pulled, the electric motor 23 starts, and the cutting tool 11 rotates.

As shown in FIGS. 2 and 4, the handle part 40 comprises a carrying handle 44, which is rearward of the manipulatable handle 41. The carrying handle 44 has a loop shape, which has a first coupling part 44a at one end and a second coupling part 44b at the other end. The first coupling part 44a is coupled to a rear portion of the manipulatable handle 41, which extends rightward of the fixed cover 12. The second coupling part 44b is coupled to an upper portion of the motor housing 20. In the state in which the cutting tool 11 is vertical, the carrying handle 44 extends along the motor shaft 23a in the front-rear direction. In the state in which the cutting-machine main body 10 has been moved to the bottom dead center, the carrying handle 44 extends generally in the horizontal direction. In the state in which the cutting-machine main body 10 has been locked at the bottom dead center by the bottom-dead-center lock pin 19, the user can carry the benchtop cutting machine 1 by grasping the carrying handle 44.

As shown in FIGS. 1 and 2, a turntable-fixing mechanism 60 is provided at a lower portion of the table-extension part 5. A grip part 61 is provided at a front portion of the table-extension part 5. The grip part 61 has recesses and projections (ridges) on a circumferential-edge portion so that the user can easily grasp and rotate the grip part 61. The user can grasp the grip part 61 and rotate the turntable 4 in the horizontal direction relative to the base 2. A fixing rod 62 extends in the front-rear direction rearward from the grip part 61 in the interior of the table-extension part 5. The fixing rod 62 is supported, by threaded engagement, in the interior of the table-extension part 5. The grip part 61 is rotatable, using the fixing rod 62 as the axial center. When the grip part 61 is rotated about the axis of the fixing rod 62, the fixing rod 62 displaces in the front-rear direction. By displacing the fixing rod 62 rearward and causing the rear end to engage with the base 2, the turntable 4 can be positioned at an arbitrary miter angle relative to the base 2. By displacing the fixing rod 62 forward, the positioning of the turntable 4 at the arbitrary miter angle can be released.

As shown in FIG. 1, a positive-lock mechanism 63 is provided on the lower portion of the table-extension part 5. By using the positive-lock mechanism 63, the turntable 4 can be positioned at one of the prescribed miter angles that respectively correspond to the positioning, recessed parts 7b of the miter scale plate 7. A lock-release lever 64 and the positioning pin 64a are provided on the positive-lock mechanism 63. The lock-release lever 64 is provided more rearward and more downward than the grip part 61 at the front portion of the table-extension part 5. The positioning pin 64a extends in the front-rear direction along the longitudinal direction of the table-extension part 5 at a lower portion of the table-extension part 5. The positioning pin 64a is provided at substantially the same height as the miter scale plate 7. The rear end of the positioning pin 64a is capable of entering any one of the positioning, recessed parts 7b by being displaced rearward. In addition, the rear end of the positioning pin 64a is capable of disengaging from the positioning, recessed part 7b by being displaced forward.

A front portion of the positioning pin 64a shown in FIG. 2 is coupled to the lock-release lever 64. When the lock-release lever 64 is pressed downward, the positioning pin 64a displaces forward. The rear end of the positioning pin 64a, which has displaced forward, disengages from the positioning, recessed part 7b. Consequently, when the positioning of the turntable 4 is released by the manipulation of the grip part 61, the turntable 4 can be rotated freely in the left-right direction. When the lock-release lever 64 is lifted upward, the positioning pin 64a displaces rearward. The rear end of the positioning pin 64a abuts an outer-circumferential edge of the miter scale plate 7. When the grip part 61 is grasped and the turntable 4 is rotated in the horizontal direction, the positioning pin 64a enters one of the positioning, recessed parts 7b, which are provided on the outer-circumferential edge of the miter scale plate 7. Thus, the turntable 4 is positioned at one of the prescribed miter angle positions that respectively correspond to the positioning, recessed parts 7b.

As shown in FIG. 6, a tilt-fixing mechanism 65, which positions and holds the main-body support arm 50 such that it is tiltable in the left-right direction, is provided on a front portion of the table-extension part 5. The tilt-fixing mechanism 65 comprises a tilt-fixing manipulatable part 66 and a transmission shaft 66a. The tilt-fixing manipulatable part 66 is provided between the grip part 61 and the front end of the table-extension part 5. The tilt-fixing manipulatable part 66 can be rotated about its axis coaxially with the grip part 61. The tilt-fixing manipulatable part 66 has recesses and projections (ridges), the pattern of which differs from the pattern of the recesses and projections (ridges) of the grip part 61, on its circumferential-edge portion such that the user can easily grasp and rotate the tilt-fixing manipulatable part 66. Consequently, when the user grasps the tilt-fixing manipulatable part 66 and the grip part 61, the user can easily (tactilely) distinguish between the tilt-fixing manipulatable part 66 and the grip part 61 based on the difference in ridge patterns, and thereby mis-manipulation can be prevented.

When the tilt-fixing manipulatable part 66 shown in FIGS. 5, 6 is rotated, the transmission shaft 66a rotates about its axis. The transmission shaft 66a extends in the front-rear direction along the longitudinal direction of the table-extension part 5 to a lower portion of the main-body support arm 50. A receiving part 67, which is movable along a slot 67a extending in an arcuate shape about the left-right tilting pivot 50a, is provided at a lower portion of the main-body support arm 50. The receiving part 67 is screw-coupled to the rear end of the transmission shaft 66a. Rotation of the receiving part 67 about the axis of the transmission shaft 66a is restricted by the side surface of the slot 67a. Consequently, when the tilt-fixing manipulatable part 66 is rotated in the tightening direction, an axial force is created by the transmission shaft 66a between the main-body support arm 50 and the arm-support part 4b. Consequently, the main-body support arm 50 and the arm-support part 4b are pressed in the front-rear direction, and thereby the main-body support arm 50 is fixed at an arbitrary left-right tilt angle relative to the arm-support part 4b. When the tilt-fixing manipulatable part 66 is rotated in the loosening direction, the axial force of the transmission shaft 66a is released. Consequently, the main-body support arm 50 becomes tiltable in the left-right direction about the left-right tilting pivot 50a.

Thus, in the embodiment shown in FIG. 7, the benchtop cutting machine 1 comprises the motor shaft 23a of the electric motor 23, the first intermediate shaft 32 and the output shaft 37. The first intermediate shaft 32 is rotated about its axis by the output (rotational energy) of the motor shaft 23a. The output shaft 37 is rotated about its axis by the output (rotational energy) of the first intermediate shaft 32 so as to cause the mounted cutting tool 11 to rotate. In the above-described embodiment, the rotational energy of the first intermediate shaft 32 is transmitted to the output shaft 37 by a set of intervening gears. The fan 24 is mounted on the first intermediate shaft 32. The fan 24 rotates about its axis with the first intermediate shaft 32 so as to generate the draft for cooling the electric motor 23 and the first intermediate shaft 32.

Thus, the fan 24 is mounted on the first intermediate shaft 32, not on the motor shaft 23a. By mounting the fan 24 on the first intermediate shaft 32, the fan 24 cools not only the electric motor 23 but also the first intermediate shaft 32. Further, the path of the draft is made longer along the motive-power path, which includes the first intermediate shaft 32. Thereby, the cooling effect can be improved, when utilized with the housing that covers (encloses) the motive-power path. It is noted that one or a plurality of intermediate shafts may be provided between the motor shaft 23a and the output shaft 37.

In the embodiment shown in FIG. 7, the first intermediate shaft 32 is directly coupled to the motor shaft 23a, or rotates about its axis at the same rotational speed as the motor shaft 23a. Thus, the first intermediate shaft 32 is disposed close to the electric motor 23. For example, the first intermediate shaft 32 may be coupled to the motor shaft 23a without any intervening reduction gears or the like. Consequently, the fan 24, which is provided on the first intermediate shaft 32, can effectively cool the electric motor 23, which is located relatively close to the fan 24. However, in other embodiments of the present teachings, the first intermediate shaft 32 may be indirectly coupled to the motor shaft 23a, as long as the rotational energy from the motor shaft 23a is ultimately transmitted to the first intermediate shaft 32 to rotate it.

In the embodiment shown in FIG. 7, the first intermediate shaft 32 comprises the upstream end part (portion) 32a that receives the output (rotational energy) from the motor shaft 23a, and the downstream end part portion 32s that directly or indirectly transmits the output (rotational energy) to the output shaft 37. The fan 24 is located on the side, on which the downstream end part 32s is located, of (relative to) the longitudinal center of the first intermediate shaft 32. Therefore, the draft, which flows from the electric motor 23, passes at least a majority of the first intermediate shaft 32 before reaching the fan 24. Thereby, the first intermediate shaft 32 also can be effectively cooled.

In the embodiment shown in FIG. 7, the axial length 24e of the fan 24 is longer than 1/4 of the diameter of the fan 24. Thus, the fan 24 is elongated in its axial direction and has a relatively small diameter. Consequently, the diameter of the intermediate-shaft housing 31, which houses the fan 24 and the first intermediate shaft 32, can be made smaller without reducing the volume of the draft generated by the fan 24.

In the embodiment shown in FIG. 7, the axial center line 32w of the first intermediate shaft 32 is (disposed, located) in the virtual orthogonal plane S1 that is orthogonal to the output shaft 37, or is inclined by 10° or less relative to the virtual orthogonal plane S1. In an embodiment in which the cutting tool 11 is a circular saw blade, the first intermediate shaft 32 is oriented to be substantially parallel to the disk (flat side) surface of the circular saw blade. Consequently, enlargement of the cutting-machine main body 10 in the direction of the output shaft 37 can be avoided.

In the embodiment shown in FIG. 7, the motor shaft 23a and the first intermediate shaft 32 are coaxially disposed. Therefore, the housing that covers the motor shaft 23a and the first intermediate shaft 32 can be made smaller in its radial direction. Or the draft for cooling the electric motor 23 and the first intermediate shaft 32 flows substantially straight. Consequently, a reduction of the volume of the draft can be curtailed.

In the embodiment shown in FIG. 7, the electric motor 23 is housed (radially enclosed) by (in) the motor housing 20, which is made from a synthetic resin (polymer). The first intermediate shaft 32 is housed (radially enclosed) by (in) the intermediate-shaft housing 31, which is made of a light metal. Therefore, insulation of conductive parts around the electric motor 23 can be ensured by the motor housing 20. In addition, the heat generated in the first intermediate shaft 32 can be transmitted to the light-metal intermediate-shaft housing 31, which serves as a heat sink for cooling the intermediate shaft 32.

In the embodiment shown in FIG. 2, the fan 24 is disposed such that the fan 24 overlaps the saw blade, which is the cutting tool 11, in a side view, which is in the axial direction of the output shaft 37. Therefore, the fan 24 is installed in the space around the saw blade that has a relatively large area. Consequently, the cutting machine can be made more compact.

In the embodiment shown in FIG. 7, the electric motor 23 is an AC motor. Because AC motors generate more heat and have a larger volume than DC motors, the present feature can achieve remarkable cooling efficiency and a remarkable downsizing effect as well.

The embodiment shown in FIG. 7 includes the two bearings 32h, 32i, which support the first intermediate shaft 32 to be rotatable about its axis. The fan 24 is located between the two bearings 32h, 32i. Therefore, the two bearings 32h, 32i stably support the fan 24 with the first intermediate shaft 32.

The embodiment shown in FIG. 7 includes the fan-housing part 31g. The intermediate-shaft-housing part 31f, which has a smaller cross-sectional area than the fan-housing part 31g, is also provided. The intermediate-shaft-housing part 31f (radially encloses) houses a portion of the first intermediate shaft 32 on the upstream side of the fan 24 in the draft. The buffer part 31e, which comprises a step caused by a difference in the cross-sectional area between the intermediate-shaft-housing part 31f and the fan-housing part 31g, is provided. Therefore, the draft passes the intermediate-shaft-housing part 31f, which has the small cross-sectional area, and reaches the fan-housing part 31g, which has the large cross-sectional area. Because the draft is dispersed by the buffer part 31e before the fan 24, the draft can flow smoothly.

In the embodiment shown in FIG. 10, the fan 24 comprises blades 24a each extending in the radial direction. The blades 24a each comprise the blade-inner-peripheral part 24b, which bulges in the rotational direction T, on the rotation inner-circumference side; i.e. the blade-inner-peripheral parts 24b are located within the radially inward portion of the fan 24. The blades 24a each comprise the blade-outer-peripheral part 24c, which bulges in the direction opposite to the rotational direction T, on the rotation outer-circumference side; i.e. the blade-outer-peripheral parts 24c are located within the radially outward portion of the fan 24. Owing to this configuration, the blades 24a can generate a strong draft.

In the embodiment shown in FIG. 10, the blade-outer-peripheral parts 24c comprise the reverse inclined parts 24d, which extend from the bottom of the recess of the blade-outer-peripheral parts 24c in the rotational direction T and in the radially outward direction. All of the reverse inclined parts 24d are entirely located in a region that is radially outward of one half of the radius R of the fan 24. Thus, the reverse inclined parts 24d are located only in the outer circumferential region (portion) of the fan 24. Thereby, the fan 24 can effectively generate the draft.

In the embodiment shown in FIG. 10, the blade-outer-peripheral parts 24c comprise the reverse inclined parts 24d, which extend from the bottom of the recess of the blade-outer-peripheral parts 24c in the rotational direction T and in the radially outward direction. All of the reverse inclined parts 24d are entirely located in a region that is radially outward of the middle of the radial length of the blade 24a. Thus, the reverse inclined parts 24d are located only in the outer circumferential region of the fan 24 (i.e. only outward of the middle of the radial length of the fan 24). Thereby, the fan 24 can effectively generate the draft.

In the embodiment shown in FIG. 10, the extension direction of the reverse inclined parts 24d at the outer circumferential edge is inclined by 30°–60° relative to the virtual radial line Y of the fan 24. In other words, the outer circumferential edge portion of each of the reverse inclined parts 24d forms an angle of 30°–60° with a radially extending line Y of the fan 24. Owing to this structure, the blades 24a can effectively generate the draft.

The embodiment shown in FIG. 9 also includes the fixed cover 12, which covers the upper portion of the cutting tool 11, and the fan housing 31d, which houses (radially encloses) the fan 24. The left exhaust port 32p is provided in the fan housing 31d. The left exhaust port 32p is open toward the fixed cover 12. Therefore, the draft is exhausted from the fan housing 31d toward the fixed cover 12. Consequently, the draft is less likely to directly blow toward (against) the user, and/or the volume of the draft that directly blows against the user can be reduced.

In the embodiment shown in FIG. 7, the electric work machine comprises the motor shaft 23a of the electric motor 23 and the first intermediate shaft 32. The first intermediate shaft 32 is disposed coaxially with the motor shaft 23a and is rotated about its axis by the output (rotational energy) of the motor shaft 23a. The fan 24 is mounted on the first intermediate shaft 32. The fan 24 rotates about its axis with the first intermediate shaft 32 so as to generate the draft for cooling the electric motor 23 and the first intermediate shaft 32.

Thus, the fan 24 is mounted on the first intermediate shaft 32, not on the motor shaft 23a. By mounting the fan 24 on the first intermediate shaft 32, the fan 24 cools not only the electric motor 23 but also the first intermediate shaft 32. Further, by utilizing the first intermediate shaft 32, the motor shaft 23a can be shortened and the motor housing 20 can be made smaller. Or the path of the draft can be made longer along the motive-power path, which includes the first intermediate shaft 32. Thereby, the cooling effect can be improved, when utilized with the housing that covers (radially encloses) the motive-power path.

Other embodiments according to the present disclosure are explained below. It is noted that, in the explanation below, the same reference signs are assigned to the structures that are identical to those in the first embodiment, and the explanation thereof is omitted.

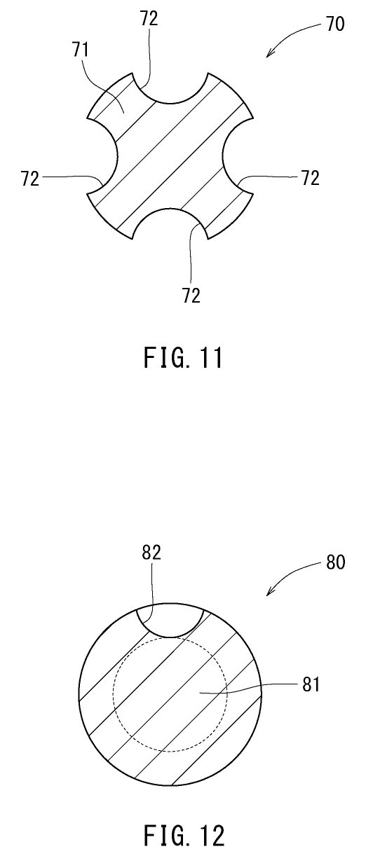

As shown in FIG. 11, a first intermediate shaft 70 of the second embodiment comprises a cross-section-reduced part 71. The cross-section-reduced part 71 is formed by a plurality of first recesses 72, which extend along the outer circumferential surface of the first intermediate shaft 70. The cross-section of the first recesses 72 has an arcuate shape (preferably, a circular-arc shape). The first recesses 72 are formed, for example, such that four of the first recesses 72 are arranged side by side in the circumferential direction. The first recesses 72 linearly extend along the axial direction. The first recesses 72 are each formed by ball-end milling. Two, three, five or more of the first recesses 72 may be formed along the circumferential direction. The depth of the first recesses 72 may be an arbitrary depth.

As shown in FIG. 12, a first intermediate shaft 80 of the third embodiment comprises a cross-section-reduced part 81. The cross-section-reduced part 81 is formed by a second recess 82, which extends along the outer circumferential surface of the first intermediate shaft 80. The cross-section of the second recess 82 has an arcuate shape (preferably, a circular-arc shape). The second recess 82 is formed in a spiral or helical manner. The second recess 82 is formed by ball-end milling.

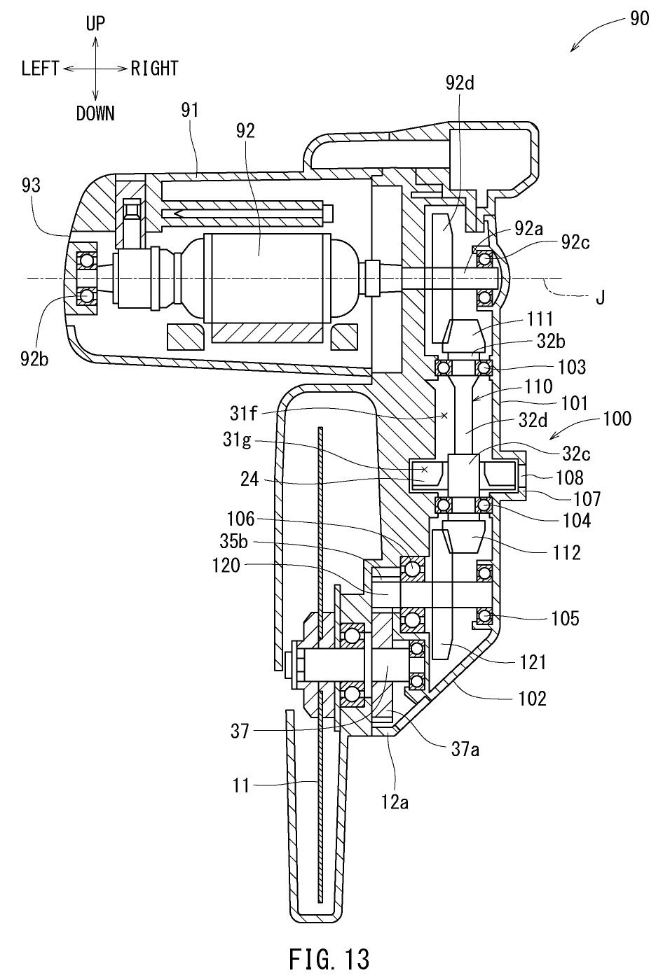

As shown in FIG. 13, a cutting-machine main body 90 of the fourth embodiment comprises the cutting tool 11 and a motor housing 91, which is disposed upward of the cutting tool 11. The motor housing 91 is a substantially circular-tube shaped member that extends in the left-right direction. An electric motor 92 is housed in the motor housing 91. A motor shaft 92a is provided at the center of the motor 92. The motor shaft 92a extends in the left-right direction along the motor axis J, which is orthogonal to a side surface of the cutting tool 11. The motor shaft 92a is supported by a first bearing 92b and a second bearing 92c such that it is rotatable about the motor axis J. A first drive-side bevel gear 92d is integrally mounted on a right portion of the motor shaft 92a. Air-intake ports 93, which are capable of taking in outside air, are provided in a left surface of the motor housing 91.

The cutting-machine main body 90 comprises a motive-power transmitting part 100, which transmits the driving force of the motor shaft 92a to the output shaft 37. The motive-power transmitting part 100 is housed in an intermediate-shaft housing 101 and a gear housing 102. The intermediate-shaft housing 101 is coupled to an opening in the right end of the motor housing 91. The gear housing 102 couples an opening in the lower end of the intermediate-shaft housing 101 and an opening in the right end of the gear-housing part 12a.

A first intermediate shaft 110 is housed in the intermediate-shaft housing 101. The first intermediate shaft 110 extends in the up-down direction such that it is orthogonal to the motor shaft 92a. The first intermediate shaft 110 is supported by a third bearing 103 and a fourth bearing 104 such that it is rotatable about an axis. A first driven-side bevel gear 111 is formed at the upper end of the first intermediate shaft 110. The first driven-side bevel gear 111 meshes with the first drive-side bevel gear 92d. Thereby, the first intermediate shaft 110 receives the rotational power of the motor shaft 92a and rotates. In addition, a second drive-side bevel gear 112 is formed at the lower end of the first intermediate shaft 110.

The first intermediate shaft 110 comprises the upstream part 32b, the downstream part 32c and the small-diameter part 32d, between the third bearing 103 and the fourth bearing 104. The fan 24 is mounted on the downstream part 32c such that the fan 24 is integrally rotatable with the downstream part 32c. The intermediate-shaft housing 101 comprises a fan housing 107, which houses the fan 24. An exhaust port 108, which is open rightward, is formed in the fan housing 107. When the fan 24 rotates, a cooling draft is introduced from the air-intake ports 93 into the intermediate-shaft housing 101, by way of the motor housing 91. The draft, which has flowed into the intermediate-shaft housing 101, passes the intermediate-shaft housing part 31f and the fan-housing part 31g, and is exhausted from the exhaust port 108. Thereby, the electric motor 92 and the first intermediate shaft 110 are cooled.

A second intermediate shaft 120 and the output shaft 37 are housed in the gear housing 102 and the gear-housing part 12a. The second intermediate shaft 120 extends in the left-right direction such that it is orthogonal to the first intermediate shaft 110. It is supported by a fifth bearing 105 and a sixth bearing 106 such that it is rotatable about an axis. A second driven-side bevel gear 121 is integrally mounted on the second intermediate shaft 120. The second driven-side bevel gear 121 meshes with the second drive-side bevel gear 112. Thereby, the second intermediate shaft 120 receives the rotational power of the motor shaft 92a via the first intermediate shaft 110 and rotates. The second intermediate shaft 120 comprises the reduction gear 35b, which meshes with the reduction gear 37a of the output shaft 37. The output shaft 37 receives the rotation of the second intermediate shaft 120 and rotates.

Various modifications can be added to the embodiments described above. For example, the sliding compound miter saw is illustrated as the benchtop cutting machine. Instead of this, the present disclosure may be applied to benchtop circular saws. In addition, the present disclosure may be applied to electric work machines, such as angle grinders, die grinders, and concrete vibrators.

The fan may be provided on the second intermediate shaft or the third intermediate shaft. The fan may be provided on the upstream part of the first intermediate shaft.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved benchtop cutting machines, including without limitation, sliding compound miter saws, and dual-bevel slide compound miter saws, sliding saws, etc.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EXPLANATION OF THE REFERENCE NUMBERS

1 Benchtop cutting machine

2 Base

2a Holder

3 Upward-protruding part

4 Turntable

4a Table upper surface

4b Arm-support part

5 Table-extension part

5a Slot

5b Kerf board

6 Positioning fence

6a Movable fence

6b Positioning surface

7 Miter scale plate

7a Fixing screw

7b Positioning, recessed part

8 Indicator

9 Knob

10 Cutting-machine main body

10a Up-down swing shaft

11 Cutting tool

12 Fixed cover

12a Gear-housing part

12b Hole part

12c Hole part

12d Gear-housing coupling part

13 Movable cover

14 Fixing screw

15 Outer flange

16 Inner flange

17 Bottom-dead-center stopper

18 Top-dead-center stopper

19 Bottom-dead-center lock pin

19a Through hole

20 Motor housing

20a Fixing screw

20b Hole part

20c Hole part

23 Electric motor

23a Motor shaft

23b Stator

23c Rotor

23d Commutator

23e First bearing

23f Second bearing

23g Air-intake port

24 Fan

24a Blade

24b Blade-inner-peripheral part (radially inward portion)

24c Blade-outer-peripheral part (radially outward portion)

24d Reverse inclined part

24e Length

X Radial region

Y Virtual radial line

30 Motive-power transmitting part

31 Intermediate-shaft housing

31a Motor-housing coupling part

31b Hub holding part

31c Reduced-part housing

31d Fan housing

31e Buffer part

31f Intermediate-shaft-housing part

31g Fan-housing part

31h Hub

32 First intermediate shaft

32a Upstream end part

32b Upstream part

32c Downstream part (large-diameter part)

32d Small-diameter part (cross-section-reduced part)

32e Rear inclined surface

32f Front inclined surface

32g Flange part

32h Third bearing

32i Fourth bearing

32j Washer

32n Rear exhaust port

32p Left exhaust port (exhaust port)

32r Upper exhaust port

32s Downstream end part

32t Drive-side bevel gear

32u Circlip

32w Axial center line

33 Gear housing

33a Intermediate-shaft-housing coupling part

33b Fixed-cover coupling part

33c Hole part

33d Hole part

33e Fixing screw

33f Fixing screw

34 Bearing box

34a Hole part

34b Hole part

34c Hole part

34d Fixing screw

35 Second intermediate shaft

35a Driven-side bevel gear

35b Reduction gear

35c Fifth bearing

35d Sixth bearing

35e Washer

35f Rubber ring

35g Washer

35h Stop ring

36 Third intermediate shaft

36a Idler gear

36b Seventh bearing

36c Eighth bearing

37 Output shaft

37a Reduction gear

37b Ninth bearing

37c Tenth bearing

40 Handle part

41 Manipulatable handle

42 Switch lever

44 Carrying handle

44a First coupling part

44b Second coupling part

50 Main-body support arm

50a Left-right tilting pivot

50b Upper part

51 Slide bar

51a First bar

51b Second bar

52 Slide base

52a Bottom-dead-center-stopper contact part

52b Top-dead-center-stopper contact part

60 Turntable-fixing mechanism

61 Grip part

62 Fixing rod

63 Positive-lock mechanism

64 Lock-release lever

64a Positioning pin

65 Tilt-fixing mechanism

66 Tilt-fixing manipulatable part

66a Transmission shaft

67 Receiving part

67a Slot

70 First intermediate shaft

71 Cross-section-reduced part

72 First recess

80 First intermediate shaft

81 Cross-section-reduced part

82 Second recess

90 Cutting-machine main body

91 Motor housing

92 Electric motor

92a Motor axis

92b First bearing

92c Second bearing

92d First drive-side bevel gear

93 Air-intake port

100 Motive-power transmitting part

101 Intermediate-shaft housing

102 Gear housing

103 Third bearing

104 Fourth bearing

105 Fifth bearing

106 Sixth bearing

107 Fan housing

108 Exhaust port

110 First intermediate shaft

111 First driven-side bevel gear

112 Second drive-side bevel gear

120 Second intermediate shaft

121 Second driven-side bevel gear

J Motor axis

S1 Virtual orthogonal plane

T Rotational direction

1. A cutting machine comprising:
a motor having a motor shaft that outputs rotational energy;
an intermediate shaft that is configured to be rotated about its axis by the rotational energy of the motor shaft, the intermediate shaft being separate from but directly or indirectly coupled to the motor shaft;
an output shaft that is configured to be rotated about its axis by the rotational energy of the intermediate shaft so as to cause a cutting tool mounted thereon to rotate, the output shaft being separate from but directly or indirectly coupled to the intermediate shaft; and
a fan that is mounted on the intermediate shaft and is configured to be rotated about its axis with the intermediate shaft so as to generate a draft that cools the motor and the intermediate shaft.

2. The cutting machine according to claim 1, wherein the intermediate shaft rotates about its axis at the same rotational speed as the motor shaft.

3. The cutting machine according to claim 1, wherein:
the intermediate shaft comprises an upstream end portion that, directly or indirectly, receives the rotational energy from the motor shaft, and a downstream end portion that transmits the rotational energy, directly or indirectly, to the output shaft; and
the fan and the downstream part are located on the same side of the intermediate shaft relative to the center of the intermediate shaft in its longitudinal direction.

4. The cutting machine according to claim 1, wherein:
the fan has an axial length and a diameter; and
the axial length of the fan is longer than 1/4 of the diameter of the fan.

5. The cutting machine according to claim 1, wherein the intermediate shaft has an axial center line that (i) extends in a virtual orthogonal plane that is orthogonal to the output shaft, or (ii) is inclined by 10° or less relative to the virtual orthogonal plane.

6. The cutting machine according to claim 1, wherein the motor shaft and the intermediate shaft are coaxial.

7. The cutting machine according to claim 1, further comprising:
a motor housing that is made from a synthetic polymer and houses the motor; and
an intermediate-shaft housing that is made of a light metal and radially encloses the intermediate shaft.

8. The cutting machine according to claim 1, wherein the fan is disposed such that the fan overlaps a saw blade, which is the cutting tool, in a side view, which is in the axial direction of the output shaft.

9. The cutting machine according to claim 1, wherein the motor is an AC motor.

10. The cutting machine according to claim 1, further comprising:
two bearings that support the intermediate shaft to be rotatable about its axis,
wherein the fan is located between the two bearings.

11. The cutting machine according to claim 1, comprising:
a fan-housing part that radially encloses the fan;
an intermediate-shaft-housing part that has a smaller cross-sectional area than the fan-housing part and radially encloses a portion of the intermediate shaft on an upstream side of the fan in the draft; and
a buffer part having a step formed by the difference in the cross-sectional areas of the intermediate-shaft-housing part and the fan-housing part.

12. The cutting machine according to claim 1, wherein:
the fan comprises one or more blades that extend(s) radially;
the blade(s) (each) comprise(s) a radially inward portion that bulges in a rotational direction, and a radially outward portion that bulges in a direction opposite to the rotational direction.

13. The cutting machine according to claim 12, wherein:
the radially outward portion of the blade(s) comprises a reverse inclined part that extends radially outward from a bottom of a recess in the rotational direction; and
all of the reverse inclined part(s) is (are) entirely located in a region of the fan that is radially outward of one half of the radius of the fan.

14. The cutting machine according to claim 12, wherein:
the radially outward portion of the blade(s) comprises a reverse inclined part that extends radially outward from a bottom of a recess in the rotational direction; and
all of the reverse inclined part(s) is (are) entirely located in a region of the fan that is radially outward of the middle of the radial length of the blade.

15. The cutting machine according to claim 14, wherein an outer circumferential edge portion of the reverse inclined part(s) of the blade(s) forms an angle of 30°–60° with a line extending radially from the radial center of the fan.

16. The cutting machine according to claim 1, further comprising:
a fixed blade cover that covers a portion of the cutting tool; and
a fan housing that houses the fan;
wherein an exhaust port in the fan housing opens toward the fixed blade cover.

17. The cutting machine according to claim 2, wherein:
the intermediate shaft is directly coupled to the motor shaft;
the intermediate shaft comprises an upstream end portion that, directly or indirectly, receives the rotational energy from the motor shaft, and a downstream end portion that transmits the rotational energy, directly or indirectly, to the output shaft; and
the fan and the downstream part are located on the same side of the intermediate shaft relative to the center of the intermediate shaft in its longitudinal direction.

18. The cutting machine according to claim 17, further comprising:
two bearings that support the intermediate shaft to be rotatable about its axis,
wherein the fan is located between the two bearings.

19. The cutting machine according to claim 18, wherein:
the fan comprises one or more blades that extend(s) radially;
the blade(s) (each) comprise(s) a radially inward portion that bulges in a rotational direction, and a radially outward portion that bulges in a direction opposite to the rotational direction;
the radially outward portion of the blade(s) comprises a reverse inclined part that extends radially outward from a bottom of a recess in the rotational direction;
all of the reverse inclined part(s) is (are) entirely located in a region of the fan that is radially outward of one half of the radius of the fan; and
an outer circumferential edge portion of the reverse inclined part(s) of the blade(s) forms an angle of 30°–60° with a line extending radially from the radial center of the fan.

20. An electric work machine comprising:
a motor having a motor shaft that outputs rotational energy;
an intermediate shaft that is coaxial with the motor shaft and is configured to be rotated about its axis by the rotational energy of the motor shaft, the intermediate shaft being separate from but directly or indirectly coupled to the motor shaft; and
a fan that is mounted on the intermediate shaft and is configured to be rotated about its axis with the intermediate shaft so as to generate a draft that cools the motor and the intermediate shaft.
